(19) United States
(12) Patent Application Publication
(10) Pub. No.: US 2004/0219936 A1
(43) Pub. Date: Nov. 4, 2004

(54) Method of distributing messages

(76) Inventor: Ari Kontiainen, Tampere (FI)

Correspondence Address: Crawford Maunu, Suite 390, 1270 Northland Drive, St Paul, MN, 55120, US

(21) Appl. No.: 10/433,635

(22) PCT Filed: Dec. 4, 2001
(86) PCT No.: PCT/FI01/01052

(30) Foreign Application Priority Data
Dec. 5, 2000 (FI) 20002665

(51) Int. Cl. H04Q 7/20

(52) U.S. Cl. 455/466; 455/412.1

(57) ABSTRACT

A method of distributing messages in a communications system, in which method a message is sent (4-2) from a message originator (MS1 . . . MS5, WS1 . . . WS5) to a message delivery node (S1) including information that identifies a first predefined recipient list (LIST A . . . LISTX) stored in association with the message delivery node (S1). The method further comprises steps in which at least one logical operator is sent with the message; the first recipient list (LIST A . . . LISTX) is processed in the message delivery node (S1) according to at least one logical operator so as to provide a temporary second recipient list for delivery of the respective message; and the message is forwarded to the recipients of the temporary second recipient list.

### FIELD OF THE INVENTION

The invention relates to messaging services in communications systems and, more particularly, to handling the recipient list of a message.

### BACKGROUND OF THE INVENTION

E-mail (electronic mail) can be described as the exchange of computer-stored messages by telecommunication. E-mail can be exchanged between online service users in Internet networks or networks other than the Internet, both public and private. E-mail messaging allows a user to send text files or non-text files, such as graphic images and sound files, as attachments. E-mail is one of the most popular services in the Internet.

Most e-mail systems include a text editor for composing messages. The user then sends the message to a recipient by specifying the recipient's address. The user can also send the same message to several users at once, i.e. to all users defined in the list of recipients. This is called broadcasting or multicasting.

SMS (Short Message Service) is a service for sending short text messages between mobile stations or other devices that supports the SMS. An example of the present short message services is the SMS of the GSM (Global System for Mobile communication) system. In the GSM system short messages cannot be longer than 160 alpha-numeric characters.

SMS messages are transferred on the signalling channels over the air interface, and therefore no traffic channel is required for transmission. As a result, the tariff for sending short messages is relatively low. Further, SMS messages do not require the mobile station to be active or within the coverage range of the mobile system and may be stored for a number of days until the phone becomes active or reachable. SMS messages can also be sent to mobile stations from personal computers (PC) by means of a web site offering an SMS message transmission service. These features have made the SMS service very popular among mobile phone users.

Typically, short message is transmitted via a specific service unit to which the originator of the message has a subscribership. This service unit is often referred to as a Short Message Service Center (SMSC). The SMS message is sent by the originator to the SMSC which must then forward the message to the recipient according to a destination address included in the message. To do this, the SMSC sends an SMS request to the home location register (HLR) in order to obtain routing information on the current location of the recipient, i.e. a mobile subscriber. Once the HLR receives the request, it responds to the SMSC with the subscriber's status: 1) inactive or active; 2) where subscriber is roaming, i.e. the routing information. The SMSC forwards the short message to a mobile network element (typically a mobile exchange) serving the current location of the recipient mobile subscriber. The mobile network requests the mobile station of the recipient, and if it responds, the short message becomes delivered.

As in the e-mail system, the user of the short message service can also send the same message to several recipients simultaneously, e.g. to all users defined in a list of recipients.

However, there is a problem relating to the use of the message distribution lists in practice. The lists are typically predefined lists which are intended to be used frequently for transmission of messages to a predefined group of recipients. If the sender wishes to send messages to a group of recipients, he/she must define new list of recipients or send a separate message to each desired recipient. Some times the desired list may be almost identical to one of the existing lists, but there is no simple or rapid way to modify the existing distribution list. In other words, it is difficult to delete recipients to whom the user does not want to send a message for one reason or another from an almost correct recipient list. It is also time-consuming to modify the list by selecting suitable recipients or sorting out unsuitable recipients, and the user has to manually go through the list and select only those recipients the user is willing to contact.

### SUMMARY OF THE INVENTION

An object of the invention is an easier and more flexible mechanism for handling message recipient lists in communications systems.

This object and other advantages provided by the invention are achieved by a method as claimed in claim 1, a system as claimed in claim 5 and a server as claimed in claim 6. Preferred embodiments of the invention are disclosed in the dependent claims.

According to the invention and its preferred embodiments, if an almost correct recipient list exists, there is a way to use that list by modifying it. The modification can be performed by selecting suitable recipients or deleting unsuitable recipients. The modification and/or selection is performed with the help of different kinds of new operators/operations.

The idea is related to messaging services when a user has personal recipient lists or recipient groups, e.g. a short message group or an e-mail list. The idea is also related to messaging services when a user has access to other readily defined distribution lists.

At least one logical operation is provided which can be used for temporarily modifying a recipient list by a sender of a message. When the sender wishes to send a message according to the existing recipient list, he provides the message with at least one logical operand. This logical operand defines which recipients should be deleted from the existing list, and/or according to which criteria the recipients on the list should be selected or deleted. More generally, the at least one logical operator defines how the existing recipient list should be processed or modified in order to obtain a temporary recipient list for delivery of this specific message. The communications network, the network node or the server which is responsible for the delivery then modifies the existing recipient list according to the logical operand and delivers the message according to the modified recipient list.

In a preferred embodiment the existing recipient lists are stored on the network side, and the sender provides the message with an identifier which is linked to the desired recipient list, along with the at least logical operand. The delivery functionality on the network side has an additional logic for handling the lists temporarily so that some recipients can be left out from a certain messaging round without permanently changing the saved list. The logical operations may include “minus” or “where” or “within” or “if” operations, for example.

### BRIEF DESCRIPTION OF THE DRAWINGS

In the following the invention will be described by means of preferred embodiments with reference to the attached drawings, in which

FIG. 1 is a general system chart of a communications system to which the invention can be applied;

FIG. 2 shows an example of a more detailed structure of a database DB;

FIG. 3a illustrates an example of a more detailed structure of the recipient list of subscriber MS1;

FIG. 3b illustrates an example of a more detailed structure of the recipient list of subscriber MS2;

FIG. 3c illustrates an example of the more detailed structure of the recipient list of subscriber WS3;

FIG. 4 shows the signal chart of using a distribution list in one embodiment of the invention.

### DETAILED DESCRIPTION OF THE INVENTION

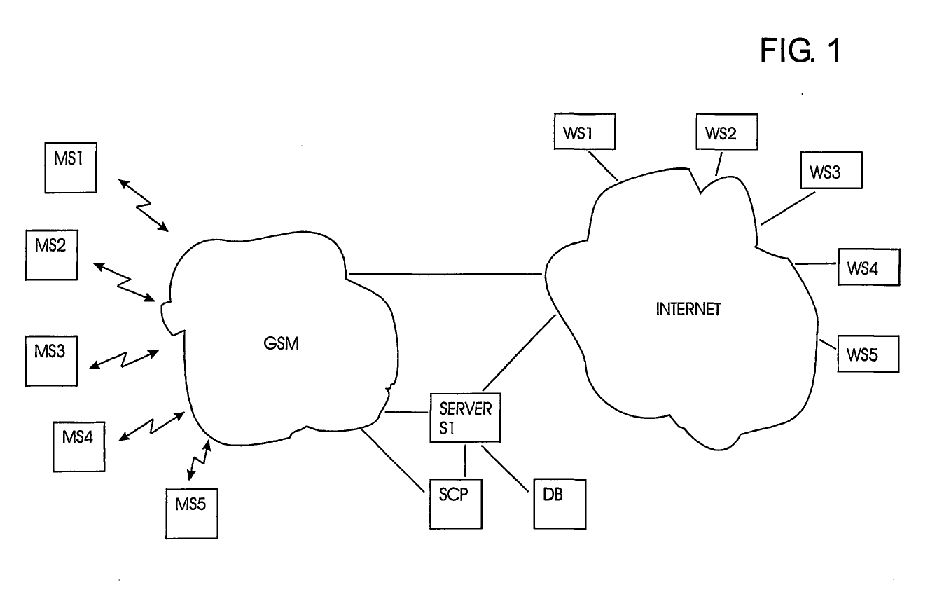

FIG. 1 shows a general system chart of a communications system to which the invention can be applied. In FIG. 1 five subscribers MS1 (Mobile Station 1), MS2, MS3, MS4 and MS5 are connected to the communications system, in this case to a digital mobile system, such as the GSM system. The mobile stations MS1 to MS5 can be conventional mobile stations having a short message service capability.

Although the invention will be described in the following by means of a short message and a short message service, and by means of an e-mail message and an e-mail message service, a message may be any type of message, such as one of the following messages: a short message, an instant message, an e-mail message, a multimedia message, a unified messaging message, a WAP (Wireless Application Protocol) message or a SIP (Session Initiation Protocol) message. The mobile stations may also be mobile stations equipped with e.g. an instant message, an e-mail message, a multimedia message, a unified messaging message, a WAP message or a SIP message service.

In order to be able to use the functionality of the invention and its embodiments, a user does not have to be a mobile user but he or she can also be a user of other communication equipment or programs e.g. a user of a conventional personal computer and its programs.

The GSM system may be directly connected to the Internet. In addition, the GSM system is connected to a message server S1 of the invention. The message server S1 may be connected to the GSM network in the manner of an ordinary short message service centre.

The message server S1 can also be connected to an intelligent network, for instance to an intelligent network service control point SCP, in which case the message server S1 can initiate a message in the GSM network as an intelligent network service.

The message server S1 can also be directly connected to the Internet.

FIG. 1 also shows five workstations WS1, WS2, WS3, WS4 and WS5 connected to the Internet. By means of these workstations the user or a message service provider can, through the Internet user interface of the server S1, such as a WWW (Word Wide Web) page, modify the message distribution lists or participate by means of an IP telephone (Internet Protocol, Voice over IP) in the operation according to the invention.

Instead of the work stations WS1 to WS5, the user can use a conventional mobile station MS, which has an Internet browser and is able to set up a data link to the Internet, for modification of distribution lists. A user can possibly also modify his or her distribution list(s) and user data by means of short messages instead of or as an alternative to the Internet user interface. A database DB represents a database associated with the message server S1.

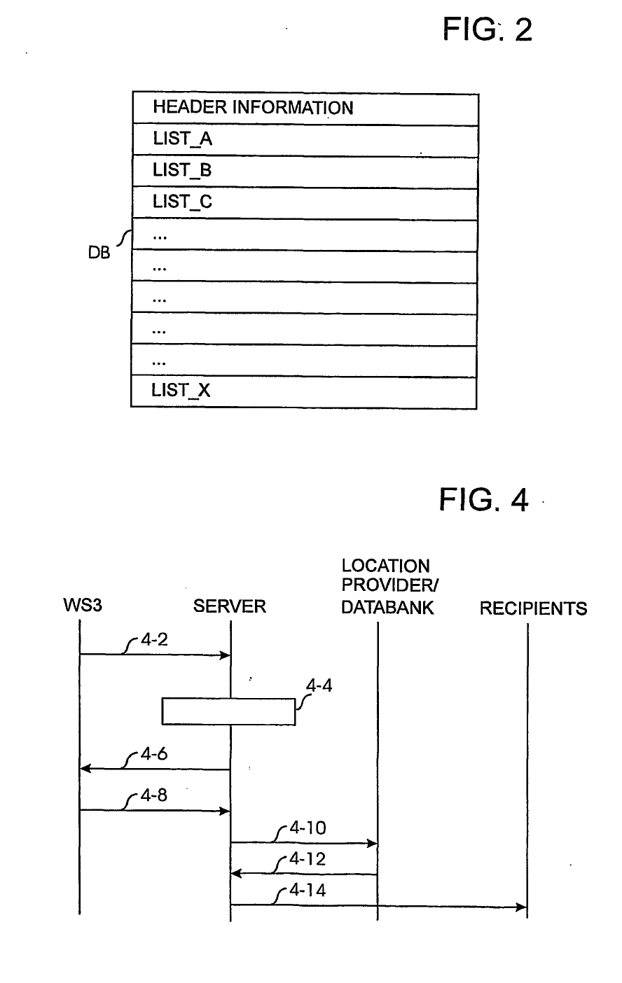

FIG. 2 shows an example of a more detailed structure of the database DB of server S1. In FIG. 2 the database DB, which may have been placed in connection with server S1, consists of a number of recipient lists: LIST_A, LIST_B, LIST_C . . . LIST_X. These recipient lists are called the first recipient lists, since these lists are the original lists defined for the different users of the communications system. The information on recipient list(s) can be stored in the database DB as mentioned above, and a user can update his list(s) e.g. by sending a message to the server S1. This update can be performed whenever information has changed in the user's recipient list.

The invention is described further hereinafter, by way of examples, with reference to the accompanying drawings 3a, 3b and 3c which show different recipient lists stored in the database DB. Other types of databases or directories can also be used to describe the invention and its preferred embodiments. They can be e.g. a company's relational databases comprising addresses and/or information on persons, an operator's own client database, an address and delivery list directory of the program called Microsoft Outlook, or some common LDAP (L D A P )-based directory of persons. The idea of the invention is that any existing delivery list or directory can be dynamically narrowed by any predefined criteria.

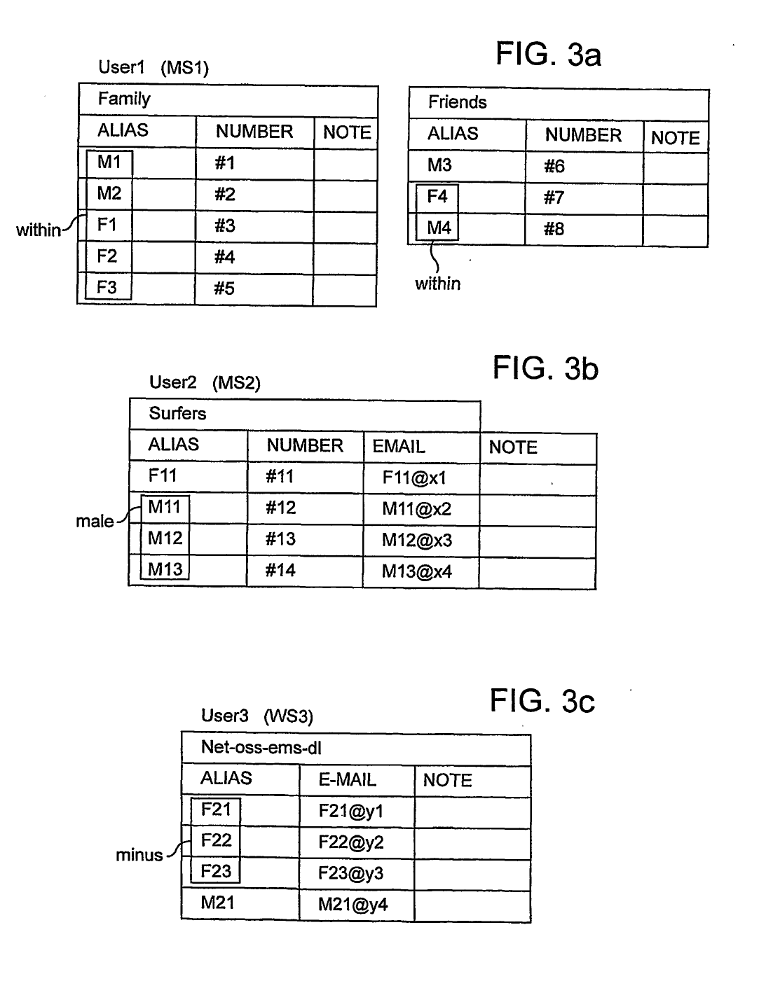

FIG. 3a shows an example of the more detailed structure of the recipient list of subscriber MS1. Subscriber MS1 has two different lists, i.e. the list FAMILY and the list FRIENDS. The list FAMILY comprises five subscriber family members, their names being M1 (Male number 1), M2, F1 (Female number 1), F2, F3. The list FRIENDS comprises three subscriber friends, their names being M3, F4 and M4.

FIG. 3b shows an example of a more detailed structure of the recipient list of subscriber MS2. The recipient list consists of the list SURFERS. Altogether four subscribers, their alias names being F11 (Female number 11), M11 (Male number 11), M12 and M13 have been stored on that list.

FIG. 3c shows an example of a more detailed structure of the recipient list of subscriber WS3. The recipient list consists of the list Mydistribution-list. Altogether four subscribers, their alias names being F21 (Female number 21), F22, F23 and M21 (Male number 21) have been stored on that list.

The user names (alias), telephone numbers (number) and any notable matters (note) can be stored for each member on the lists in the database DB of S1. Also other type of information on subscribers can be stored or can be otherwise available for the communications system. This information may comprise information on age, marital status, location of subscribers etc.

Although the structures of databases for other users of FIG. 1 are not shown, they can also have the same type of recipient lists comprising e.g. the user names (alias), telephone numbers (number), e-mail addresses (e-mail) and any notable matters (note) as information for message distribution lists.

Server S1 has predetermined logical operations for processing and modifying the predefined recipient list on a message by message basis. Each logical operation has a predetermined operator or identifier which triggers the operation. When the user sends a message which identifies a predefined recipient list stored in the database DB, and contains at least one of the logical operators, server S1 will process the predefined recipient list according to the logical operation indicated by said at least one logical operator so as to generate a temporary second recipient list(s) according to the invention for delivery of the specific message. This temporary list will be automatically deleted after the delivery of the message. The original list is maintained unchanged in the database DB. Naturally, if the message from the sender contains no logical operand but only the identifier of a predetermined recipient, the server S1 will deliver the message according this list without any changes.

The temporary recipient list is usually a list narrowed from the first temporary list, since the user often wants to select suitable recipients or delete out unsuitable recipients for the purpose of his respective message.

The temporary recipient list can also be the first list replaced partly or totally by some users if the user sends along with his message e.g. some new names, which should be included in the second list.

Still another alternative for the temporary recipient list is a widened recipient list. In fact, the first list can be widened if the user sends along with his message one or more new addresses or telephone numbers, which should be added to the list in order to obtain the temporary second list for delivery of the message. The operator the user sent does not delete a member from the first recipient list.

The temporary recipient list may also be created by combining two or more predefined lists by an “and” operation. In the latter case, a message from the sender identifies the lists to be combined.

The invention will now be illustrated by means of exemplary message delivery cases.

Let us assume that user WS3 wants to send a “Let's buy a present” e-mail to all except person M21, whose birthday it is. The existing recipient list My-distribution-list is stored in server S1. User WS3 can then indicate the recipients of his e-mail message in the mail program using an expression like “my-distribution-list minus M21”. In the expression my-distribution-list the name of the already available first distribution list is stored in the database DB of server S1. The distribution list my-distribution-list can either be defined by the user himself or reside in a service offerer minus is the operator for deleting some persons or lists of persons from the whole distribution list. M21 is the alias name of the person who will not get this e-mail message, even if he is a member of the original mailing list my-distribution-list. Upon reception of the message from user WS3, server S1 modifies the already available message distribution list or recipient list my-distibution-list according to the operator received in the message in such a way that the e-mail message is delivered to persons F21, F22 and F23 but not to person M21. FIG. 3c shows the modified recipient list MINUS and the member M21 of the mailing list, who will be sorted out from the temporary recipient list.

In a second example it is assumed that the user of the mobile station MS2 wants to send a short message SM to male members of a group of people in the distribution list SURFERS stored in the database DB of the server S1. For the recipients of the message he marks “suffers where male”, where surfers is the name of the already available and defined distribution list, where is the operator which defines that a selection operation should be carried out to the distribution list SURFERS, and male is the criteria by which the recipients are selected. Server S1 receives the message from the MS2 and modifies the original recipient list SURFERS according to the received operator and criteria. In other words, server S1 provides a temporary recipient list which includes the male members from the recipient list SURFERS. The temporary list Male within the original list SURFERS is shown in FIG. 3b. As a result the short message is delivered to persons M11, M12 and M13 according to their telephone numbers or e-mail addresses in the list.

In yet another example, user MS1 wants to inform close family members and friends about an extempore summer barbecue. However, the user does not want to disappoint persons who are not in the same city at the moment. He defines recipients as “(friends and family) within 20 miles” in the message (e.g. a short message), where (friends and family) is the combination of user defined lists FAMILY and FRIENDS shown in FIG. 3a, within is the operator which defines the type of selection operation to be carried out, and 20 miles is the criteria by which the recipients are selected. In this case the criteria is that the recipient must be within 20 miles from the location of the sender. Again server S1 receives the message from MS1 and generates a new temporary recipient list according to the logical operation defined by the operator and the criteria in the received message. In other words, server S1 checks the location of each member in the lists FAMILY AND FRIENDS. Server S1 may, for example, make an interrogation to a subscriber database of a mobile communications system (e.g. the GSM). Server S1 finds out that all other members of the lists but M3 are located within 20 miles from MS1. Therefore, server S1 leaves M3 out of the temporary recipient list modified for this message and forwards according to the temporary list. As a result all but person M3 are invited to the barbecue.

If a user uses such criteria in a message that are not met by all recipients, a signal can be sent to the sender of the original message in order to point out that the original message may not be delivered to some recipients of the original mailing list with that certain narrowing criterion.

If the sender of an original message wants to restrict his recipient list so that only his or her friends who are older than 18 years will receive an e-mail, but some members of his recipient list lack this age information in a database to which these criteria is used, the server of the communications system may send an additional message to the sender prior to proceeding the recipient list further. In this way the sender learns that he can alter the narrowing criteria or that all members of a recipient list may not receive the message since some members do not meet the narrowing criteria.

FIG. 4 shows a signalling diagram which illustrates the distribution of a message when the narrowing criteria cannot be checked from the relevant recipient list stored in server S1. In step 4-2, a workstation WS3 sends a message to server S1. The message comprises an invitation to a barbecue, the name of the recipient list My-distribution-list, and one or more operators according to the invention. In this case the criteria are “within 20 miles and age over 18”. In step 4-4, server S1 receives the message. It also interprets and evaluates the narrowing criteria. It is a task of server S1 to alter the original recipient list or lists with the criteria sent along the message. Because WS3 sent two criteria, i.e. 20 miles and age over 18 server S1 must check that these two criteria are met by each recipient in the first list. If server S1 detects that the original recipient list My-distribution-list stored in the database DB does not include the age information of the names F2 and F3, server S1 can send a message to WS3 in step 4-6 in order to inform the sender that server S1 cannot confirm the age criteria. Server S1 can also convey information to WS3 that the SERVER is not allowed to check the age information from a data bank. In step 4-8, the workstation WS3 sends an additional message to server S1 in which it permits server S1 to ask the age information from the data bank or from some information provider. In step 4-10, server S1 enquires the age information from the data bank, and in response to this enquiry the data bank can return the missing information in step 4-12. In step 4-14, server S1 sends further the original message to the recipient of the second recipient list.

Other information providers can also be requested to send the requested information to the processor of the message. An information provider could be e.g. a location provider who could have and/or provide the location information of recipients of the message of a message sender for the information processor.

The invention and its preferred embodiments enhance the current Instant Messaging IM search functionalities thus allowing more flexible ways of communication. The invention and its preferred embodiments can be used in group messaging, e.g. in chat applications.

The idea is also related to messaging services when a user has access to other already defined distribution lists defined by e.g. a company, a service provider, an operator, an activity club or some other reference group or body.

It will be understood that the embodiment described herein is merely exemplary and that a person skilled in the art may make many variations and modifications without departing from the spirit and scope of the invention. E.g. various kind of logical operators/operations different from those described above can be used for selecting and deleting recipients from already defined distribution lists. Other operators could be e.g. if and time. All such modifications and variations are intended to be included within the scope of the invention as defined in the appended claims.

1. A method of distributing messages in a communications system, which method comprises:
sending a message from a message originator to a message delivery node including information that identifies a first predefined recipient list stored in association with the message delivery node;
sending at least one logical operator with the message;
processing the first recipient list in the message delivery node according to at least one logical operator so as to provide a temporary second recipient list for delivery of the respective message; and
forwarding the message to the recipients of the temporary second recipient list.

2. A method as claimed in claim 1, wherein the first recipient list is narrowed by sorting out some members of the first recipient list according to the at least one logical operator and at least one criterion received in the message.

3. A method as claimed in claim 1, wherein the logical operation indicated by the logical operator in the message combines two predefined reception lists for delivery of the respective message.

4. A communications system for distributing messages, in which system a message is sent from a message originator to a message delivery node including information that identifies a first predefined recipient list stored in association with the message delivery node, wherein the communications system further includes:
at least one logical operator which is sent with the message;
the first recipient list, which is processed in the message delivery node according to at least one logical operator so as to provide a temporary second recipient list for delivery of the respective message; and
the message which is forwarded to the recipients of the temporary second recipient list.

5. A delivery node for distributing messages in a communications system, in which system a message delivery node is adapted to receive a message sent from a message originator, which message includes information identifying a first predefined recipient list stored in association with the message delivery node, wherein the delivery node is further adapted to process the first predefined recipient list according to at least one logical operator, which operator is sent with the message, so as to provide a temporary second recipient list for delivery of the respective message, and wherein the message is adapted to forward to the recipients of the temporary second recipient list.

6. A method as claimed in claim 2, wherein the logical operation indicated by the logical operator in the message combines two predefined reception lists for delivery of the respective message.
